(19) United States
(12) Patent Application Publication
(10) Pub. No.: US 2017/0184256 A1
(43) Pub. Date: Jun. 29, 2017

(54) Solid-state iilumination system having an array of light shields

(71) Applicant: Amerillum LLC, Oceanside, CA (US)

(72) Inventors: Justin L. Horvath, Oceanside, CA (US); Ron Lancial, Oceanside, CA (US)

(21) Appl. No.: 14/998,098

(22) Filed: Dec. 23, 2015

(51) Int. Cl. F21K 9/69; F21V 19/00; F21V 13/02; F21V 21/34; F21V 5/00; F21V 11/16

(52) U.S. Cl. CPC F21K 9/69; F21V 5/007; F21V 11/16; F21V 13/02; F21V 21/34; F21V 19/003; F21Y 2115/10

(57) ABSTRACT

An illumination system includes a substrate; a one-dimensional (1D) array of light emitting diodes (LEDs) distributed on the substrate along a first direction; a 1D array of lenses optically coupled in one-to-one correspondence with the 1D array of LEDs; and a 1D array of light shields optically coupled in one-to-one correspondence with the 1D array of lenses, each light shield of the 1D array of light shields having an input aperture and an output aperture, the light shield comprising a lateral surface extending between the input aperture and the output aperture in a second direction substantially orthogonal to the first direction.

### FIELD OF THE TECHNOLOGY

The present technology relates generally to solid-state luminaires, and more specifically to illumination systems having an array of light emitting diodes (LEDs) and an array of light shields in one-to-one correspondence with the array of LEDs.

### BACKGROUND

Many types of electric light sources, such as, incandescent lamps, fluorescent lamps, compact fluorescent lamps (CFL), cold cathode fluorescent lamps (CCFL), high-intensity discharge lamps have been used for general illumination purposes. The foregoing types of electric light sources are gradually being replaced in many general illumination applications by solid state light sources, e.g., light-emitting diodes (LEDs).

Development of LED-based illumination systems, e.g., LED-based pendant lighting fixtures or LED-based troffer lighting fixtures, has focused on ways to output as much of the light emitted by the LEDs as possible into the ambient while providing at least some directionality of propagation to the output light to make the latter safe and useful for general illumination purposes. For example, controlling glare of LED-based illumination systems and uniformity of illumination provided by LED-based illumination systems can be very challenging because the LEDs are quasi-point sources that emit very bright light. For instance, more recently, it has become desirable to reduce the size of apertures of the foregoing light fixtures, but still deliver the same light intensity (amount of lumens). This combination of requirements can have a potential negative affect on the comfort of people using such light fixtures. When the same amount of light is delivered from a small source, people tend to experience that source having more glare that others that use a larger aperture. Reduced aperture light fixtures, therefore, should exhibit a high degree of control of the light intensity distribution to prevent light from being emitted in the “glare region”, which is above a 55-degree incident angle (which is measured from the horizon up). Optical elements, such as reflective plates and/or transmissive plates, are placed inside the LED-based illumination systems, in proximity to the LEDs, to redirect and mix the light emitted by the quasi-point source LEDs, so glare can be reduced and uniform illumination can be provided by the LED-based illumination systems.

### SUMMARY

The present technology relates to illumination systems having an array of LEDs and an array of light shields in one-to-one correspondence with the array of LEDs.

According to a first aspect of the present technology, an illumination system includes a substrate; a one-dimensional (1D) array of light emitting diodes (LEDs) distributed on the substrate along a first direction; a 1D array of lenses optically coupled in one-to-one correspondence with the 1 D array of LEDs; and a 1D array of light shields optically coupled in one-to-one correspondence with the 1D array of lenses, each light shield of the 1D array of light shields having an input aperture and an output aperture, the light shield comprising a lateral surface extending between the input aperture and the output aperture in a second direction substantially orthogonal to the first direction.

Implementations of the first aspect may include one or more of the following features. In some implementations, the output aperture can be larger than the input aperture, and the light shield is arranged with the input aperture adjacent to a corresponding lens of the 1D array of lenses. Further, the lateral surface of the light shield can be a set of the lateral faces of a truncated pyramid, and a contour of the base of the truncated pyramid forms the output aperture. For example, the base of the pyramid can be a rectangle. Furthermore, the lateral surface of the light shield can be the lateral surface of a truncated cone, and a contour of the base of the truncated cone forms the output aperture. Additionally, the light shield can be configured in the following manner: the input aperture has a dimension D_{I}, the output aperture has a dimension D_{O}, and the input aperture and the output aperture are separated by a distance H along the second direction that satisfies the condition

$$tan \frac{θ}{2} \leq \frac{{D}_{O} - {D}_{I}}{2 H} .$$

Here, θ is a divergence angle of light transmitted through the lens along the second direction. For example, the lens is shaped such that the divergence angle of the light transmitted through the lens along the second direction is less than 70°.

In some implementations, the input aperture can be circular. In some implementations, the 1D array of light shields can include a plastic material. For example, the plastic material includes PMMA.

In some implementations, each lens of the 1D array of lenses is a plano-concave lens. For instance, a surface of the lens adjacent to a corresponding LED is concave.

In some implementations, the 1D array of lenses can include a plastic material that is transparent to light emitted by the LEDs. For example, the plastic material includes PMMA.

In some implementations, the 1D array of LEDs can include six or more LEDs separated by a distance of about 0.5″ between each other. In some implementations, the 1D array of lenses can be mounted on the substrate and supports the 1D array of light shields.

In some implementations, the illumination system can include a housing; and a mounting plate that supports the substrate. Here, the mounting plate is mounted inside the housing.

In accordance with the disclosed technologies, light that reaches the output aperture of each light shield advantageously incurs no losses as it propagates through the light shield. Additionally, the each light shield obstructs direct lines of sight to a corresponding lens for angles in the glare region, and, thus, inhabitants of rooms illuminated by the disclosed illumination fixtures, will perceive the illumination fixtures as glare free illumination fixtures.

The details of one or more implementations of the technologies described herein are set forth in the accompanying drawings and the description below. Other features, aspects, and advantages of the disclosed technologies will become apparent from the description, the drawings, and the claims.

### BRIEF DESCRIPTION OF THE FIGURES

FIGS. 1A-1B show an implementation of an illumination system having an array of LEDs and an array of light shields in one-to-one correspondence with the array of LEDs.

FIGS. 1C-1D show aspects of optical components of an illumination system like the one illustrated in FIGS. 1A-1B.

FIG. 1E shows another implementation of an illumination system having an array of LEDs and an array of light shields in one-to-one correspondence with the array of LEDs.

FIGS. 2A-2B show aspects of a lens array that can be used in the illumination systems illustrated in FIGS. 1A-1B or FIG. 1E.

FIGS. 3A-3E show aspects of a light shield array that can be used in the illumination systems illustrated in FIGS. 1A-1B or FIG. 1E.

Like elements in different figures are identified with the same reference numeral.

### DETAILED DESCRIPTION OF THE TECHNOLOGY

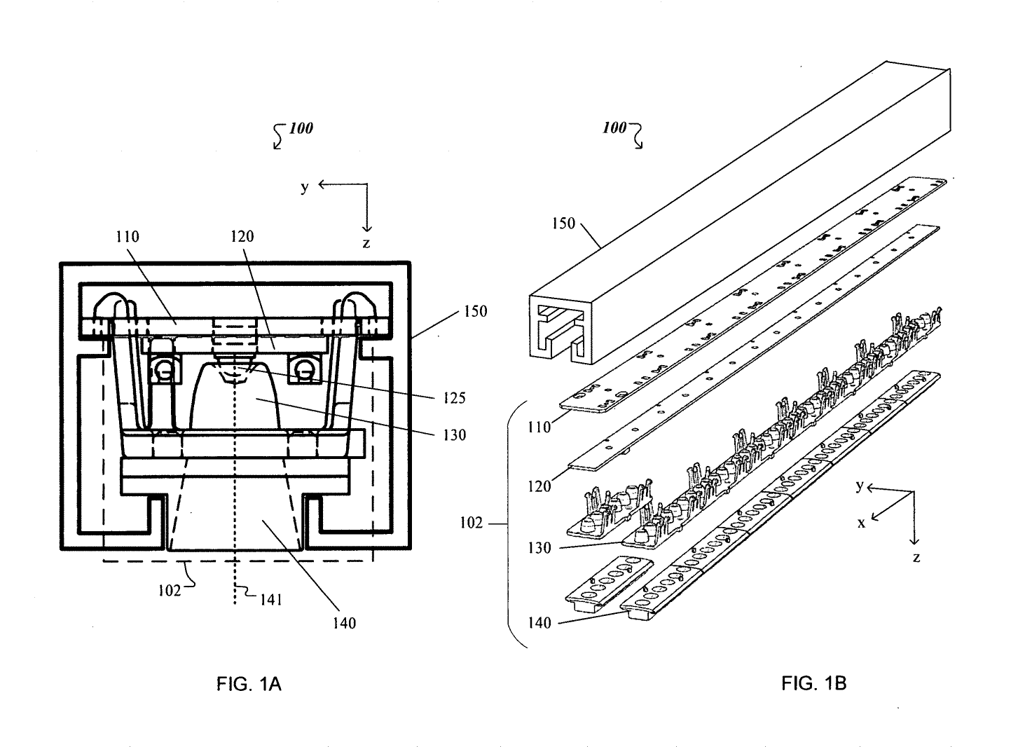

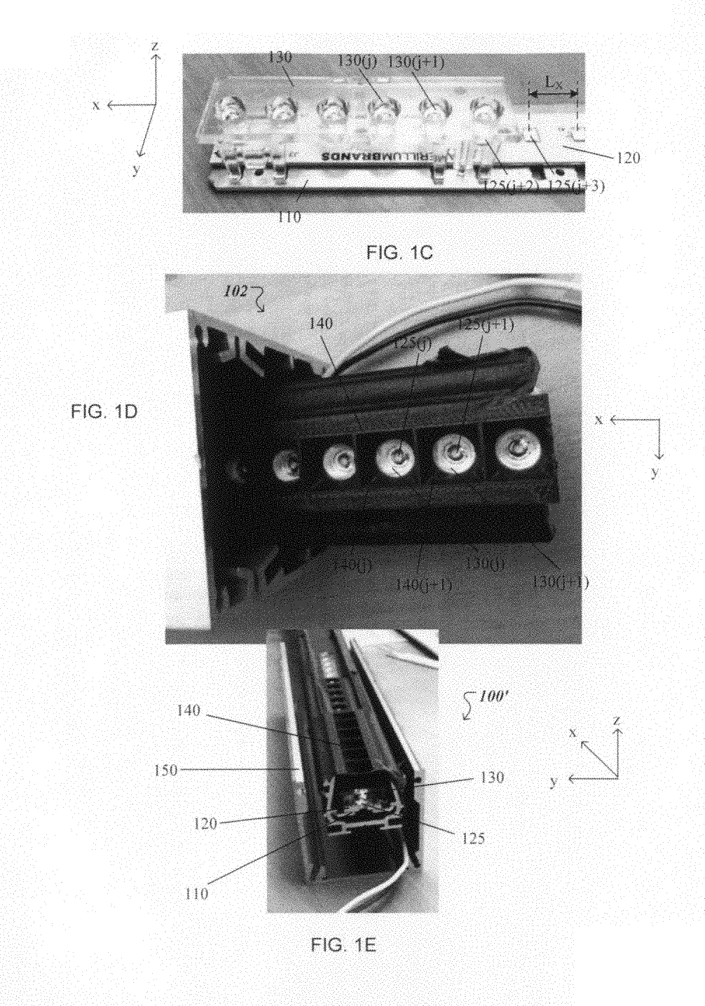

FIG. 1A is a side view, FIG. 1B is an exploded view and FIG. 1E is a perspective view of illumination fixture 100. The illumination fixture 100 includes illumination device 102 supported on a rail 150. FIG. 1D is a top view of the illumination device 102. The illumination device 102 includes a mount 110, a substrate 120, a one-dimensional (1D) array of LEDs 125, a 1D array of lenses 130 in one-to-one correspondence with the 1D array of LEDs, and a 1D array of light shields 140 (also referred to as an array of baffles) in one-to-one correspondence with the 1D array of lenses. FIG. 1C (along with FIG. 1A) shows that the lenses of the 1D array of LEDs 125 are separated from each other along a first direction (e.g., the x-axis) by a pitch Lx, and the 1D array of lenses 130 is optically coupled with the 1D array of LEDs. For example, the pitch Lx can be about 5 mm, 10 mm, 12 mm, 14 mm or other values. The substrate 120 is mounted on the mount 110 and supports the 1D array of lenses 125. Additionally, the 1D array of lenses 125 supports the 1D array of light shields 140, as shown in FIGS. 1A and 1E.

A light shield 140(j) of the 1D array of light shields 140 has an input aperture and an output aperture larger than the input aperture, where j=1 . . . N, and N≧2 is the number of LEDs in the 1D arrays of LEDs 125. The light shield 140(j) includes a lateral surface extending between the input aperture and the output aperture. Note that an optical axis 141 of the illumination device 102 passes through respective centers of the input aperture and the output aperture and is disposed along a second direction (e.g., along the z-axis) orthogonal to the first direction. Moreover, the 1D array of light shields 140 is arranged relative to the 1D array of lenses 130 such that the input aperture of the light shield 140(j) is adjacent to the corresponding lens 130(j).

The input aperture of the light shield 140(j) can be circular. In some implementations, the lateral surface of the light shield 140(j) is a set of the lateral faces of a truncated pyramid, and a contour of the base of the truncated pyramid forms the output aperture. For example, the base of the pyramid can be a rectangle, such that the output aperture is a rectangular output aperture. In other implementations, the lateral surface of the light shield 140(j) is the lateral surface of a truncated cone, and a contour of the base of the truncated cone forms the output aperture, such that the output aperture is a circular output aperture.

Light emitted by an LED 125(j) along the second direction (e.g., along the z-axis) can have a Lambertian intensity distribution and an emission divergence θ_{E}, e.g., θ_{E}≈140°. The corresponding lens 130(j) that receives the emitted light from LED 125(j) is shaped such that light transmitted through the lens along the second direction (e.g., along the z-axis) has a divergence θ that is smaller than the emission divergence θ_{E}. In some implementations, the shape of the lens 130(j) can be such that an intensity distribution of the transmitted light is bat wing-shaped in polar coordinates. The corresponding light shield 140(j) receives the light transmitted by the lens 130(j) through the input aperture and allows the received light to directly propagate along the second direction (e.g., along the z-axis) to the output aperture without impinging on the side surface of the light shield. In this manner, light that reaches the output aperture of the light shield 140(j) advantageously incurs no losses as it propagates through the light shield. Additionally, the light provided by the illumination device 102 through the output aperture of the light shield 140(j) along the second direction (e.g., along the z-axis) has the same divergence θ as the light transmitted through the lens 130(j). Moreover, the light shield 140(j) obstructs direct lines of sight to the lens 130(j) (or equivalently rays of light scattered by the lens) for angles in the range [θ/2,90°] relative to the z-axis, and, thus, an inhabitant of a room illuminated by the illumination fixture 100, will perceive the illumination fixture as a glare free illumination fixture.

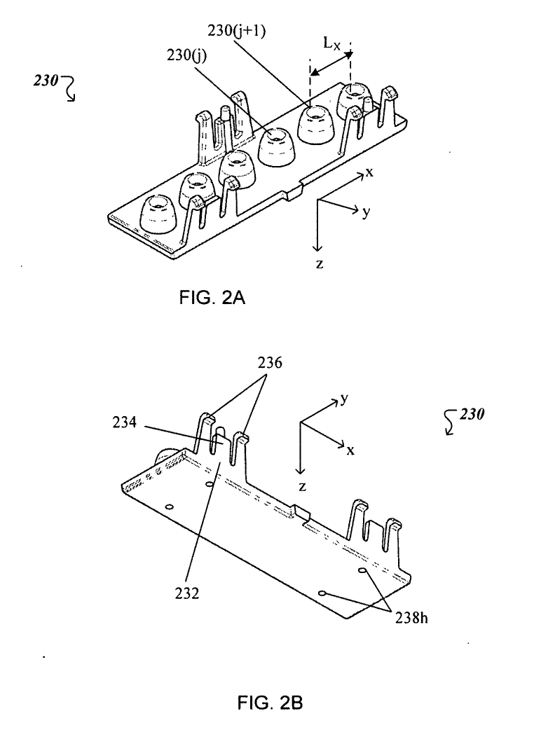

FIG. 2A is a top perspective view and FIG. 2B is a bottom perspective view of a 1 D array of lenses 230. In some implementations, the 1D array of lenses 230 can be used as the 1D array of lenses 130 in the illumination device 102. The 1D array of lenses 230 is formed (e.g., through injection molding) from a plastic material that is transparent to light emitted by the LEDs 125 of the illumination device 102. The plastic material can be Poly(methyl methacrylate) (PMMA), for instance. In some implementations, the 1D array of lenses 230 also can include scattering centers (e.g., with diffraction indices different from the plastic material matrix) configured to effectively mix spectral components of the light propagating through the lenses. The 1D array of lenses 230 includes N lenses 230(j), where j=1 . . . N. Here the number of lenses can match the number of LEDs 125 distributed on the substrate 120 of the illumination device 102. The lenses of the 1D array of lenses 230 are separated from each other along the first direction (e.g., the x-axis) by a pitch L_{X}. In this example, a lens 230(j) of the 1D array of lenses 230 is plano-concave. When the 1D array of lenses 230 is used in the illumination device 102, the lens 230(j) is arranged with the concave surface adjacent a corresponding LED 125(j) and with the planar surface adjacent a corresponding light shield 140(j). In some implementations, the lens 230(j) is shaped such that the divergence θ of the light transmitted through the lens along the z-axis is less than 70°. For example, the lens 230(j) is shaped such that the divergence θ of the light transmitted through the lens along the z-axis can be about 10°, 20°, 30°, 40°, 50° or 60°. In addition, in some cases, the shape of the lens 130(j) can be such that an intensity distribution of the transmitted light is bat wing-shaped in polar coordinates.

In this example, the 1D array of lenses 230 further includes mounting elements 232. A mounting element 232 includes one or more board mounting elements 234 to attach the 1D array of lenses 230 to the board 120 and to maintain alignment of the 1D array of lenses to the 1D array of LEDs 125, for instance. Additionally, the mounting element 232 further includes one or more plate mounting elements 236 to attach the 1D array of lenses 230 to the mount 110, for instance. Moreover, the 1D array of lenses 230 have multiple holes 238h used to mate and align the 1D array of lenses 230 to the 1D array of light shields 140, for instance.

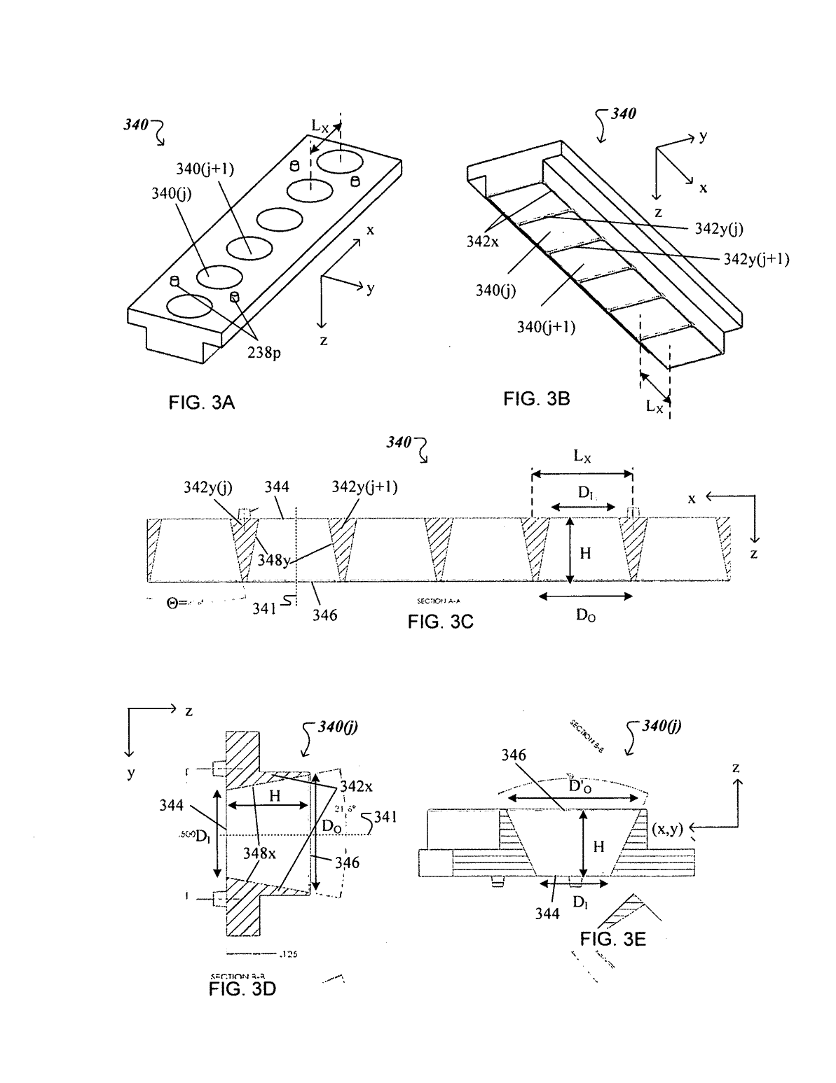

FIG. 3A is a top perspective view, FIG. 3B is a bottom perspective view and FIG. 3C is a side view cross-section (e.g., in the x-z plane) of a 1D array of light shields 340. In some implementations, the 1D array of light shields 340 can be used as the 1D array of light shields 140 in the illumination device 102. The 1D array of light shields 340 is formed from a plastic material, e.g., PMMA. The 1D array of light shields 340 includes N light shields 340(j), where j=1 . . . N. Here the number of light shields can match the number of lenses of the array of lenses 130 of the illumination device 102. The 1D array of light shields 340 includes a pair of longitudinal side walls 342x extending along the x-axis, and (N+1) transverse side walls 342y(j), where j=1 . . . (N+1), extending along the y-axis, between the pair of longitudinal side walls. The transverse side walls 342y(j) are separated from each other along the first direction (e.g., the x-axis) by a pitch Lx. A side surface of a light shield 340(j) is formed from a side surface 348y(j) of transverse side wall 342(j), a side surface of 348y(j+1) of adjacent transverse side wall 342(j+1) and portions of the longitudinal side walls 342x between the adjacent transverse side walls 342(j), 342(j+1). The light shield 340(j) has an input aperture 344 with a dimension Di and an output aperture 346 with a dimension D_{O} larger than D_{I}. The input aperture 344 and the output aperture 346 are spaced apart by a separation H, and the side surface extends between the input and output apertures. Note that an optical axis 341 of the light shield 340(j) passes through respective centers of the input aperture 344 and the output aperture 346 and is oriented, in this example, along the z-axis. FIG. 3D is an end view cross-section (e.g., in the y-z plane) and FIG. 3E is a diagonal view cross-section of the light shield 340(j). Note that in this example, the input aperture 344 is circular and the output aperture 346 is square. As such, the dimension D′_{O} of the output aperture 344 in the diagonal cross-section is D′_{O}=D_{O}*sqrt(2).

In order for light transmitted through lens 130(j) and received at the input aperture 344 of the light shield 340(j) to propagate through the light shield to the output aperture 346 without impinging onto the side surface 348x, 348y, a combination of the dimensions D_{I}, D_{O} and H of the light shield is configured to satisfy the following condition:

$$tan \frac{θ}{2} \leq \frac{{D}_{O} - {D}_{I}}{2 H} ,$$

where θ is a divergence angle of light transmitted through the lens along the z-axis. Note that the dimension of the output aperture is bound by the pitch along the x-axis, D_{O}<Lx. In the example illustrated in FIGS. 3A-3E, the combination of the dimensions D_{I}, D_{O} and H of the light shield is configured such that each of the pair of side surfaces 348x and the pair of side surfaces 348y of the light shield 340(j) form an angle of about 20° relative to each other.

In this example, the 1D array of light shields 340 further includes multiple pins 238p to mate, and maintain alignment of, the 1D array of light shields to the 1D array of lenses 130. Here, the pins 238p of the 1D array of light shields 340 are to be mated with the holes 238h of the 1D array of lenses 230.

Unless defined otherwise, all technical and scientific terms used herein have the same meaning as commonly understood by one of ordinary skill in the art to which this technology belongs.

What is claimed is:

1. An illumination system comprising:
a substrate;
a one-dimensional (1D) array of light emitting diodes (LEDs) distributed on the substrate along a first direction;
a 1D array of lenses optically coupled in one-to-one correspondence with the 1D array of LEDs; and
a 1D array of light shields optically coupled in one-to-one correspondence with the 1D array of lenses, each light shield of the 1D array of light shields having an input aperture and an output aperture, the light shield comprising a lateral surface extending between the input aperture and the output aperture in a second direction substantially orthogonal to the first direction.

2. The illumination system of claim 1, wherein
the output aperture is larger than the input aperture, and
the light shield is arranged with the input aperture adjacent to a corresponding lens of the 1D array of lenses.

3. The illumination system of claim 2, wherein
the lateral surface of the light shield is a set of the lateral faces of a truncated pyramid, and
a contour of the base of the truncated pyramid forms the output aperture.

4. The illumination system of claim 3, wherein the base of the pyramid is a rectangle.

5. The illumination system of claim 2, wherein
the lateral surface of the light shield is the lateral surface of a truncated cone, and
a contour of the base of the truncated cone forms the output aperture.

6. The illumination system of claim 2, wherein the light shield is configured in the following manner:
the input aperture has a dimension Di,
the output aperture has a dimension Do, and
the input aperture and the output aperture are separated by a distance H along the second direction that satisfies the condition
$$tan \frac{θ}{2} \leq \frac{{D}_{O} - {D}_{I}}{2 H} ,$$
where θ is a divergence angle of light transmitted through the lens along the second direction.

7. The illumination system of claim 6, wherein the lens is shaped such that the divergence angle of the light transmitted through the lens along the second direction is less than 70°.

8. The illumination system of claim 1, wherein the input aperture is circular.

9. The illumination system of claim 1, wherein the 1D array of light shields comprises a plastic material.

10. The illumination system of claim 9, wherein the plastic material comprises PMMA.

11. The illumination system of claim 1, wherein a lens of the 1D array of lenses is a plano-concave lens.

12. The illumination system of claim 11, wherein a surface of the lens adjacent to a corresponding LED is concave.

13. The illumination system of claim 1, wherein the 1D array of lenses comprises a plastic material that is transparent to light emitted by the LEDs.

14. The illumination system of claim 13, wherein the plastic material comprises PMMA.

15. The illumination system of claim 1, wherein the 1D array of LEDs includes six or more LEDs separated by a distance of 0.5″ between each other.

16. The illumination system of claim 1, wherein the 1D array of lenses is mounted on the substrate and supports the 1D array of light shields.

17. The illumination system of claim 16, further comprising
a housing; and
a mounting plate that supports the substrate, wherein the mounting plate is mounted inside the housing.
